(19) United States
(12) Patent Application Publication
(10) Pub. No.: US 2013/0086066 A1
(43) Pub. Date: Apr. 4, 2013

(54) AUTOMATED DISCOVERY AND GENERATION OF HIERARCHIES FOR BUILDING AUTOMATION AND CONTROL NETWORK OBJECTS

(71) Applicants: Thomas Anderson, JR., Lakemoor, IL (US); John Jeffers, Franklin, WI (US); Robert Gaffaney, Algonquin, IL (US); Thomas Rule, Arlington Heights, IL (US)

(72) Inventors: Thomas Anderson, JR., Lakemoor, IL (US); John Jeffers, Franklin, WI (US); Robert Gaffaney, Algonquin, IL (US); Thomas Rule, Arlington Heights, IL (US)

(73) Assignee: Siemens Akeiengesellschaft, Munich (DE)

(21) Appl. No.: 13/537,911

(22) Filed: Jun. 29, 2012

Related U.S. Application Data
(63) Continuation-in-part of application No. PCT/US2011/056414, filed on Sep. 30, 2011.
(60) Provisional application No. 61/541,925, filed on Sep. 30, 2011.

(51) Int. Cl. G06F 17/30

(52) U.S. Cl. 707/737; 707/755; 707/722; 707/E17.046

(57) ABSTRACT

Management systems, methods, and mediums. A method includes identifying a name of a first object in a plurality of objects. The plurality of objects is associated with one more devices communicably connected to a building automation and controls network. The method includes parsing characters in the name of the first object to identify a plurality of name segments separated by one or more delimiters in the name in response to identifying the one or more delimiters. The method includes identifying a type of the first object and a location of a first device associated with the first object based on the plurality of name segments. Additionally, the method includes generating a hierarchical structure for the plurality of objects based on the type and the location, the hierarchical structure comprising a name for each of the plurality of objects.

### CROSS-REFERENCE TO OTHER APPLICATIONS

This application claims priority to PCT Application Serial No. PCT/US2011/054141, filed Sep. 30, 2011, entitled “Management System with Versatile Display” and to U.S. Provisional Patent Application Ser. No. 61/541,925, filed Sep. 30, 2011, entitled “Management System Using Function Abstraction for Output Generation”, both of which are hereby incorporated by reference. This application also shares some subject matter in common with, but is otherwise unrelated to, the following patent applications, filed concurrently herewith, all of which are incorporated by reference:
U.S. patent application Ser. No. ______ for “Graphical Symbol Animation with Evaluations for Building Automation Graphics” filed Jun. 29, 2012 (Attorney Docket 2012P12588US);
U.S. patent application Ser. No. ______ for “Navigation and Filtering with Layers and Depths for Building Automation Graphics” filed Jun. 29, 2012 (Attorney Docket 2012P12596US);
U.S. patent application Ser. No. ______ for “Unified Display of Alarm Configurations Based On Event Enrollment Objects” filed Jun. 29, 2012 (Attorney Docket 2012P12591US);
U.S. patent application Ser. No. ______ for “Management System User Interface in a Building Automation System” filed Jun. 29, 2012 (Attorney Docket 2012P12595US); and
U.S. patent application Ser. No. ______ for “Management System User Interface for Comparative Trend View” filed Jun. 29, 2012 (Attorney Docket 2012P12594US).

### TECHNICAL FIELD

The present disclosure is directed, in general, to management systems and, more particularly, to automated discovery and generation of hierarchies for building automation and control network objects.

### BACKGROUND OF THE DISCLOSURE

Building automation systems encompass a wide variety of systems that aid in the monitoring and control of various aspects of building operation. Building automation systems include security systems, fire safety systems, lighting systems, and HVAC systems. The elements of a building automation system are widely dispersed throughout a facility. For example, an HVAC system may include temperature sensors and ventilation damper controls, as well as other elements that are located in virtually every area of a facility. Similarly, a security system may have intrusion detection, motion sensors and alarm actuators dispersed throughout an entire building or campus. Fire safety systems also include widely dispersed devices in the form of smoke alarms, pull stations and controllers. These building automation systems typically have one or more centralized control stations from which system data may be monitored and various aspects of system operation may be controlled and/or monitored.

Building automation systems may include vast numbers of devices and control points that may be communicated with, monitored, and controlled. Historically, management systems used to display and access data for monitoring and controlling operations of the building automation system have been relatively rigid in their user interface architecture. For example, a building automation system is made up of thousands of objects that are often organized into hierarchies. The hierarchies provide organization for users to find objects. One type of organization that may be used is a physical view that matches network and system wiring. However, this type of organization may not be useful for a user wishing to view objects in a logical view that matches a layout of a building or campus. Creating such a view may be very time consuming and requires knowledge of where each of thousands of devices and control points are installed. Creating this type of a view may be costly in terms of time and labor.

There is a need, therefore, for an automated discovery and generation of hierarchies for building automation and control network objects.

### SUMMARY OF THE DISCLOSURE

Various disclosed embodiments relate to systems and methods for automated discovery and generation of hierarchies for building automation and control network objects.

Various embodiments include management systems, methods, and mediums. A method includes identifying a name of a first object in a plurality of objects. The plurality of objects is associated with one more devices communicably connected to a building automation and controls network. The method includes parsing characters in the name of the first object to identify a plurality of name segments separated by one or more delimiters in the name in response to identifying the one or more delimiters. The method includes identifying a type of the first object and a location of a first device associated with the first object based on the plurality of name segments. Additionally, the method includes generating a hierarchical structure for the plurality of objects based on the type and the location, the hierarchical structure comprising a name for each of the plurality of objects.

The foregoing has outlined rather broadly the features and technical advantages of the present disclosure so that those skilled in the art may better understand the detailed description that follows. Additional features and advantages of the disclosure will be described hereinafter that form the subject of the claims. Those of ordinary skill in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a management system in which various embodiments of the present disclosure are implemented;

FIG. 2 illustrates a block diagram of a data processing system in which various embodiments of the present disclosure are implemented;

FIG. 3 illustrates a graphical user interface including a logical view of system objects in a system manager application in accordance with disclosed embodiments;

FIG. 4 depicts a flowchart of a process for generating a hierarchical structure for a plurality of objects in accordance with disclosed embodiments; and

FIG. 5 depicts a flowchart of a process for identifying a type of an object and a location of a device from object names in accordance with disclosed embodiments.

### DETAILED DESCRIPTION

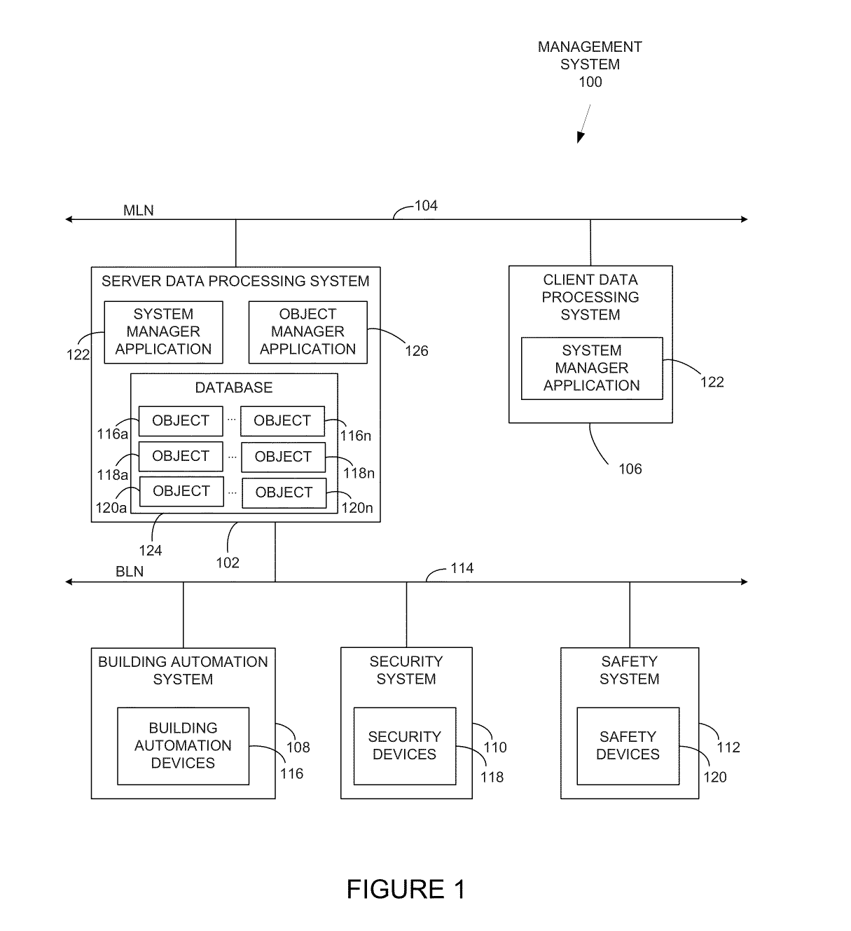

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

Embodiments of the present disclosure provide automated discovery of objects in building automation and management systems. Embodiments of the present disclosure provide options for configuring discovery of objects. Embodiments of the present disclosure provide techniques for automated creation and generation of hierarchies. The hierarchies generated in accordance with embodiments of the present disclosure provide a logical view of system objects that may match the layout of the building or buildings. Embodiments of the present disclosure allow for building managers to view and monitor objects in a manner that is organized based on the layout of devices in the building or buildings managed.

FIG. 1 illustrates a block diagram of management system 100 in which various embodiments of the present disclosure are implemented. In this illustrative embodiment, the management system 100 includes a server data processing system 102 connected, via a management level network (MLN) 104 to a client data processing system 106. The MLN 104 is a medium used to provide communication links between various data processing systems and other devices in the management system 100. MLN 104 may include any number of suitable connections, such as wired, wireless, or fiber optic links. MLN 104 may be implemented as a number of different types of networks, such as, for example, the internet, a local area network (LAN), or a wide area network (WAN). In some embodiments, elements of the management system 100 may be implemented in a cloud computing environment. For example, MLN 104 may include or be connected to one or more routers, gateways, switches, and/or data processing systems that are remotely located in a cloud computing environment.

In this illustrative embodiment, server data processing system 102 is operably connected to building automation system (BAS) 108, security system 110, and safety system 112 via building level network (BLN) 114. The BAS 108 is an environmental control system that controls at least one of a plurality of environmental parameters within a building or buildings, such as, for example, temperature, humidity, and/or lighting. The security system 110 controls elements of security within a building or buildings, such as, for example, location access, monitoring, and intrusion detection. The safety system 112 controls elements of safety within a building or buildings, such as, for example, smoke, fire, and/or toxic gas detection.

As depicted, the BAS 108 includes building automation devices 116, the security system 110 includes security devices 118, and the safety system 112 includes safety devices 120. In some embodiments, the BAS 108 may encompass the security system devices 118 and safety system devices 120. The devices 116-120 may be located inside or in proximity to one or more buildings managed using management system 100. The devices 116-120 are configured to provide, monitor, and/or control functions of the BAS 108, the security system 110, and/or the safety system 112 within one or more buildings managed using the management system 100. For example, without limitation, the devices 116-120 may include one or more field panels, field controllers, and/or field devices inside or in proximity to one or more buildings. More specifically, devices 116-120 may include one or more general-purpose data processing systems, programmable controllers, routers, switches, sensors, actuators, cameras, lights, digital thermostats, temperature sensors, fans, damper actuators, heaters, chillers, HVAC devices, detectors, motion sensors, glass-break sensors, security alarms, door/window sensors, smoke alarms, fire alarms, gas detectors, etc. The devices 116-120 may use the BLN 114 to exchange information with other components connected to the BLN 114, such as, for example, components within the BAS 108, the security system 110, the safety system 112, and/or the server data processing system 102. One or more of the devices 116-120 may also be connected via one or more field level networks (FLN) to a field panel or field controller for monitoring and controlling the respective field devices within a room, floor or other space of a building. For example, devices in the devices 116-120 may send and receive information to and from other devices in the devices 116-120 using one or more FLNs present in management system 100.

Various embodiments of the present disclosure are implemented in the management system 100. The management system 100 allows for systems and devices located throughout one or more buildings to be managed, monitored, and controlled from a single point and in a uniform manner. For example, a system manager application 122 may be installed on one or more workstations, such as server data processing system 102, client data processing system 106, and/or other devices connected via MLN 104. The system manager application 122 is a collection of software and associated data files that provides a user-modifiable and intuitive graphical user interface for allowing a user to monitor, review and control various points and devices in the management system 100. The system manager application 122 may include, for example, without limitation, executable files, user-layout-definition files, graphics control modules, an infrastructure interface, and/or a number of software extensions. In some embodiments, system manager application 122 may be an application framework as described in PCT

Application Serial No. PCT/US2011/054141, entitled “Management System with Versatile Display” and U.S. Provisional Patent Application Ser. No. 61/541,925, entitled “Management System Using Function Abstraction for Output Generation”. The server data processing system 102 includes a database that stores information about the devices 116-120 within the management system 100. A database 124 includes one or more data models of data points, devices, and other objects in the management system 100. For example, the database 124 may store values for one or more inputs and outputs of devices in the BAS 108 (e.g., temperature, alarm status, humidity). These values may be referred to as a point or data point. The database 124 may also store static information, such as model numbers, device types, and/or building and room-installation location information about devices in the management system 100. The database 124 may also store graphical models of one or more buildings managed by the management system 100. For example, the graphical models may include layouts and schematics of one or more rooms, floors and buildings managed by the management system 100.

In these illustrative embodiments, objects in the management system 100 include anything that creates, processes or stores information regarding data points or otherwise serves as a software proxy for a data point, such as analog, binary, or multistate inputs and outputs of physical devices (e.g., BAS controllers, field panels, sensors, actuators, valves, power switches, cameras, etc.). For example, one or more of the devices 116-120 may be associated with one or more objects 116a-n, 118a-n, or 120a-n. One or more of the objects 116a-n, 118a-n, or 120a-n may have properties that are based on a data point of a device in the devices 116-120. Objects may also include data files, such as, control schedules, calendars, trend reports, and the like.

In various embodiments, the database 124 includes hierarchy definitions that identify relationships between objects 116a-n, 118a-n, and 120a-n in the system. For example, a hierarchy may include a folder for “floor” in a building with multiple child folders in the form of “rooms”. Each “room” folder, in turn, may have several child objects, such as “ventilation damper”, “smoke detector”, and “temperature sensor”. Such hierarchy definitions among objects are conventional in nature and may take many forms. It will be appreciated that the use of hierarchical files in the management system 100 allows for technicians to define nearly any desirable hierarchy, the result of which is stored as one of the defined hierarchical files, as discussed further below. As referenced herein, a “point” or “data point” may be (i) any physical input or output to or from a respective controller, field device, sensor or actuator, or (ii) any virtual point associated with a control application or logic object within a field controller or field panel of the systems 108-112 that is measured, monitored or controlled. The database 124 stores files identifying different versions of hierarchies between the objects 116a-n, 118a-n, and 120a-n of the system, including those representative of the devices 116-120.

The server data processing system 102 includes an object manager application 126 to detect and manage objects in the management system 100. The object manager application 126 is a software application that runs on the server data processing system 102. The object manager application 126 includes functionality for searching for and discovering objects on the BLN 114 or objects on an FLN corresponding to points of field devices 116, 118 and 120 managed by a field panel or field controller in the BAS 108, security system 110 or safety system 112. For example, the server data processing system 102 may periodically search for objects and devices that are connected to the BLN 114. The object manager application 126 also includes functionality for organizing the discovered objects into hierarchies based on the location of the devices in the building or buildings managed by the management system 100. For example, the server data processing system 102 may generate and store one or more hierarchies in the database 124. The client data processing system 106 may load a hierarchy from the database 124 and present a building manager with a logical view of the objects according to the hierarchy as described in further detail herein.

The system manager application 122 may further include software extensions or services that provide operations of the management system 100. For example, the software extensions may include a print manager, a reporting subsystem, and a status propagation manager. For example, a reporting subsystem implemented on a workstation data processing system (e.g., server data processing system 102 or client data processing system 106) is a system that manages the acquisition of data values from the database 124 for the generation of various reports. Such reports may include, for example, trends for a temperature of a room or the like. In another example, the status propagation manager implemented on a workstation data processing system (e.g., server data processing system 102 or client data processing system 106) propagates alarm status information, among other things, to various other data objects in the system. An example of a suitable alarm propagation system is provided in U.S. patent application Ser. No. 12/566,891, filed Sep. 25, 2009, which is assigned to the assignee of the present invention and is incorporated by reference herein.

In various embodiments, system manager application 122 may, via server data processing system 102 or client data processing system 106, implement scheduling functions of the management system 100. The scheduling function is used to control points in the various systems based on a time-based schedule. For example, the scheduling function may be used to command temperature set points based on the time of day and the day of the week within the building automation devices 116.

The server data processing system 102 is connected to the BLN 114 and includes one or more hardware and/or software interfaces for sending and receiving information to and from the devices 116-120 in the BAS 108, the security system 110, and/or the safety system 112. For example, the server data processing system 102 may request and receive data regarding a status of one or more devices in the devices 116-120. The system manager application 122, via server data processing system 102 or client data processing system 106, provides a user with the functionality to monitor real-time information about the status of one or more devices and objects in the management system 100. The system manager application 122, via server data processing system 102 or client data processing system 106, also provides a user with the functionality to issue commands to control one or more devices and objects in the management system 100. For example, one or more of the devices 116-120 may implement a network protocol for exchanging information within the management system, such as building automation and controls network (BACnet) or local operation network talk (LonTalk) protocols.

BACnet is a communications protocol for building automation and control networks. The BACnet protocol allows for communication in building automation and control systems for HVAC, lighting, security and safety system applications. In various embodiments, the objects managed by the object manager application 126 are BACnet objects. For example, the server data processing system 102 may search for and identify the objects using BACnet communication protocols.

Additional descriptions and examples of the management system 100 and components that may be present within the management system 100 may be found in Patent Cooperation Treaty Application Serial No. PCT/US2011/054141, filed Sep. 30, 2011, entitled “MANAGEMENT SYSTEM WITH VERSATILE DISPLAY” and U.S. Provisional Patent Application Ser. No. 61/541,925, filed Sep. 30, 2011, entitled “MANAGEMENT SYSTEM USING FUNCTION ABSTRACTION FOR OUTPUT GENERATION”. Both of these applications are hereby incorporated by reference as if fully set forth herein.

The illustration of the management system 100 in FIG. 1 is not meant to imply physical or architectural limitations to the manner in which different illustrative embodiments may be implemented. Other components in addition to and/or in place of the ones illustrated may be used. Some components may be unnecessary in some illustrative embodiments. For example, any number of data processing systems may be used as workstations in the management system 100, while functions of the system manager application 122 may be implemented in different data processing systems in the management system 100. In other examples, embodiments of the management system 100 may not include one or more of the BAS 108, the security system 110, and/or the safety system 112.

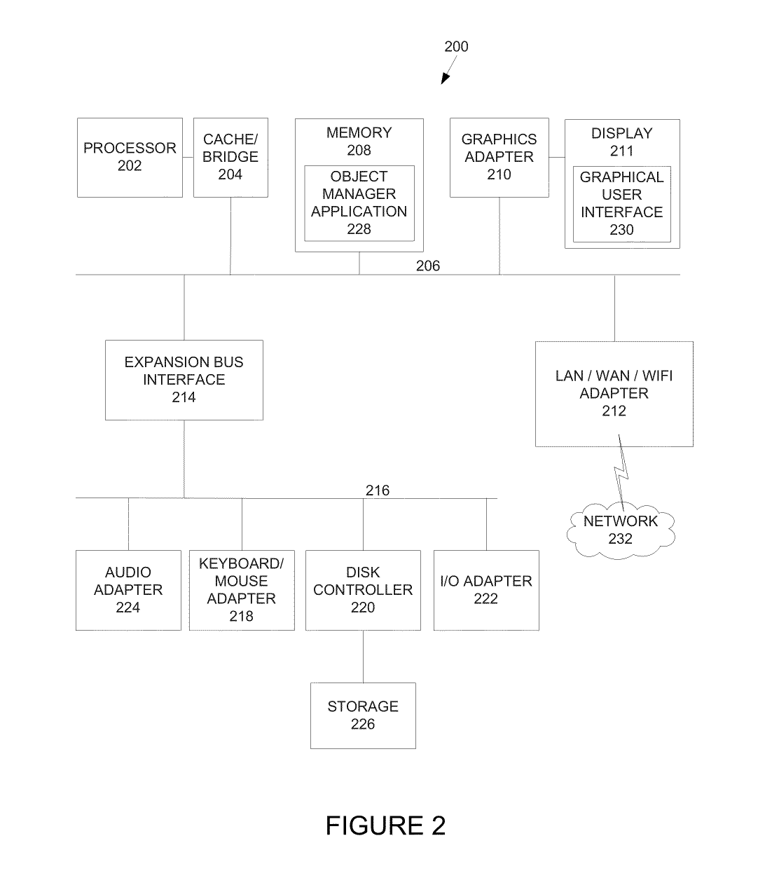

FIG. 2 depicts a block diagram of a data processing system 200 in which various embodiments are implemented. The data processing system 200 is an example of one implementation of the server data processing system 102 in FIG. 1. The data processing system 200 is also an example of the client data processing system 106.

The data processing system 200 includes a processor 202 connected to a level two cache/bridge 204, which is connected in turn to a local system bus 206. The local system bus 206 may be, for example, a peripheral component interconnect (PCI) architecture bus. Also connected to the local system bus 206 in the depicted example are a main memory 208 and a graphics adapter 210. The graphics adapter 210 may be connected to a display 211.

Other peripherals, such as a local area network (LAN)/Wide Area Network (WAN)/Wireless (e.g. WiFi) adapter 212, may also be connected to the local system bus 206. An expansion bus interface 214 connects the local system bus 206 to an input/output (I/O) bus 216. The I/O bus 216 is connected to a keyboard/mouse adapter 218, a disk controller 220, and an I/O adapter 222. The disk controller 220 may be connected to a storage 226, which may be any suitable machine-usable or machine-readable storage medium, including, but not limited to, nonvolatile, hard-coded type mediums, such as read only memories (ROMs) or erasable, electrically programmable read only memories (EEPROMs), magnetic tape storage, and user-recordable type mediums, such as floppy disks, hard disk drives, and compact disk read only memories (CD-ROMs) or digital versatile disks (DVDs), and other known optical, electrical, or magnetic storage devices.

Also connected to the I/O bus 216 in the example shown is an audio adapter 224, to which speakers (not shown) may be connected for playing sounds. The keyboard/mouse adapter 218 provides a connection for a pointing device (not shown), such as a mouse, trackball, trackpointer, etc. In some embodiments, the data processing system 200 may be implemented as a touch screen device, such as, for example, a tablet computer or a touch screen panel. In these embodiments, elements of the keyboard/mouse adapter 218 may be implemented in connection with the display 211.

Those of ordinary skill in the art will appreciate that the hardware depicted in FIG. 2 may vary for particular implementations. For example, other peripheral devices, such as an optical disk drive and the like, also may be used in addition to or in place of the hardware depicted. The depicted example is provided for the purpose of explanation only and is not meant to imply architectural limitations with respect to the present disclosure.

One of various commercial operating systems, such as a version of Microsoft Windows™, a product of Microsoft Corporation located in Redmond, Wash. may be employed if suitably modified. The operating system may be modified or created in accordance with the present disclosure as described, for example, to implement discovery of objects and generation of hierarchies for the discovered objects.

LAN/WAN/Wifi adapter 212 may be connected to the network 232, such as, for example, the MLN 104 or the BLN 114 in FIG. 1. As further explained below, the network 232 may be any public or private data processing system network or combination of networks, as known to those of skill in the art, including the Internet. Data processing system 200 may communicate over network 232 to one or more computers, which are also not part of the data processing system 200, but may be implemented, for example, as a separate data processing system.

In various embodiments of the present disclosure, the data processing system 200 is implemented as an installed workstation with an object manager application 228 installed in the memory 208. The object manager application 228 is an example of one embodiment of the object manager application 126 in FIG. 1. For example, the processor 202 executes program code of the object manager application 228 to discover objects on the network 232 and generate a hierarchy of the objects. The data processing system 200 may also generate a graphical user interface 230 to display a logical view of the objects.

In various embodiments, the data processing system 200 executes program code to perform an object discovery process. The discovery process allows a user to control a number of the total objects in a device that will be visible. For example, the data processing system 200 may generate a user interface to allow for configuration of the parameters of the object discovery process. For example, a user may select what ranges of BACnet identifiers to discover, what vendors or device manufacturers to discover, and/or what networks to discover. Each one of these features may be enabled or disabled during the object discovery process.

The data processing system 200 may also execute program code of the system manager application 122 to present a user with different views of objects in the management system 100. For example, the data processing system 200 may present a management view, a logical view, an application view, and/or a user defined view of objects in the management system 100. The management view includes a structure organized by a physical hierarchy of device and network connections. For example, the management view may include a structure organized by devices and objects on particular FLNs in the management system 100. The data processing system 200 generates this management view by filtering devices and objects discovered based on the respective network where the devices or field panel or field controller corresponding to or managing a respective object are located. The management view includes both device structure and end node objects in one expanding view. For example, the management view may be hardware centric and include all BACnet object types in a single application. The topology of the management is based on network, device and object types. The application view includes schedules, calendars, commands, and trends applications that may be employed in the management view. A user defined view may be created manually with a custom structure based on user inputs.

In various embodiments of the present disclosure, the data processing system 200 generates and displays a logical view. The logical view includes a hierarchical structure based on the location of devices and type of objects in one or more networks. For example, the logical view may be organized by location (e.g., building, floor, room or region, city, area, zone, etc.). The logical view may be created and associated with specific networks in the management view.

The data processing system 200 may generate the hierarchical structure based on delimiters in the name of the objects discovered during the object discovery process. A delimiter is a sequence of one or more characters used to specify a boundary between separate, independent regions in plain text or data streams. Some examples of delimiters include periods, commas, slashes, dashes, or any other type of recognizable character(s) that may be used to separate text. When the data processing system 200 receives the names of the objects, the data processing system 200 parses the names into name segments separated by delimiters. The data processing system 200 identifies the name segment in an object's name as a location in or in proximity to a building of the device associated with the object and a type of the object. For example, in one non-limiting example, for an object name of “Building1.Floor3.Room12.RoomTemperatureSensor”, the data processing system 200 identifies the period as a delimiter and the name segments separated by the periods as identification of the device location and object type. In this example, data processing system 200 identifies that the named object is for a room temperature sensor (e.g., a BAS device 116) that is located in building one on the third floor in room twelve by performing processes described in further detail herein.

In order to generate the hierarchical structure for the logical view of system objects, embodiments of the present disclosure utilize a naming convention for objects that allows hierarchical structure to be created automatically as objects are discovered or imported by the object manager application 228 of the data processing system 200. For example, during installation or configuration of devices or equipment in one or more buildings managed in management system 100, the installers or persons setting up the equipment utilize this naming convention to specify the location of the device or equipment and what type of device or object is being named.

Upon discovery of object names created according to this naming convention, the data processing system 200 is able to identify the location of the device 116, 118, or 120 and the type of the object corresponding to the device 116, 118, or 120. With the location and type information, the data processing system 200 then generates the hierarchical structure based on the location and type information. For example, the data processing system 200 may place objects of devices that are in the same building or same campus of buildings within a first folder for that building or campus. The data processing system 200 may then create subfolders within the first folder for objects of devices on each floor in the building and subfolders within the floor subfolders for objects of devices in each room on the floor. In some embodiments, the data processing system 200 may also generate a folder to include objects that are associated with the same device. For example, a controller or a HVAC system may have multiple objects (e.g., one or more analog and/or digital inputs and/or outputs, device states, sensor readings, etc.). The data processing system 200 may identify that each of the objects is associated with the same device and may organize the objects for this same device together in the hierarchical structure (e.g., grouped together in a subfolder for a room the device is located in) or within a separate subfolder created for the device.

The data processing system 200 may generate this hierarchical structure for the logical view of system objects in response to a request from a user to have the logical view created. For example, a user may specify through the graphical user interface 230 that the user requests to have a logical view of the objects of the devices that are located in a specified campus, building, floor and/or room. Upon receipt of this user input request and discovery of the objects in the specified location(s), the data processing system 200 generates the hierarchical structure for the objects of the devices in the specified locations as described above and provides the hierarchical structure for display to a user as a logical view of system objects.

In various embodiments, the data processing system 200 may periodically or otherwise continually perform the discovery process to determine whether a change to the objects has occurred. For example, addition, re-configuration, or removal of equipment or devices in the managed buildings may cause objects discoverable on the network to be added or removed and object names to change. Upon identification of a change to the discovered objects, the data processing system 200 updates the hierarchical structure and repopulates the logical view based on the identified changes. For example, the data processing system 200 may add objects to or remove objects from one or more folders in the hierarchical structure. The data processing system 200 may also change the folder location in the hierarchical structure or the grouping of an object in response to identifying that the name of the object changed.

The illustration of the data processing system 200 in FIG. 2 is intended as an illustrative example of one embodiment of the present disclosure and is not meant to imply physical or architectural limitations to the manner in which different illustrative embodiments may be implemented. For example, the server data processing system 102 may perform the discovery and generation of the hierarchical structure and store the hierarchical structure in a database, such as the database 124 in FIG. 1. A different data processing system, such as the client data processing system 106 in FIG. 1, may receive the stored hierarchical structure and display the hierarchical structure as a logical view of system objects in the graphical user interface 230.

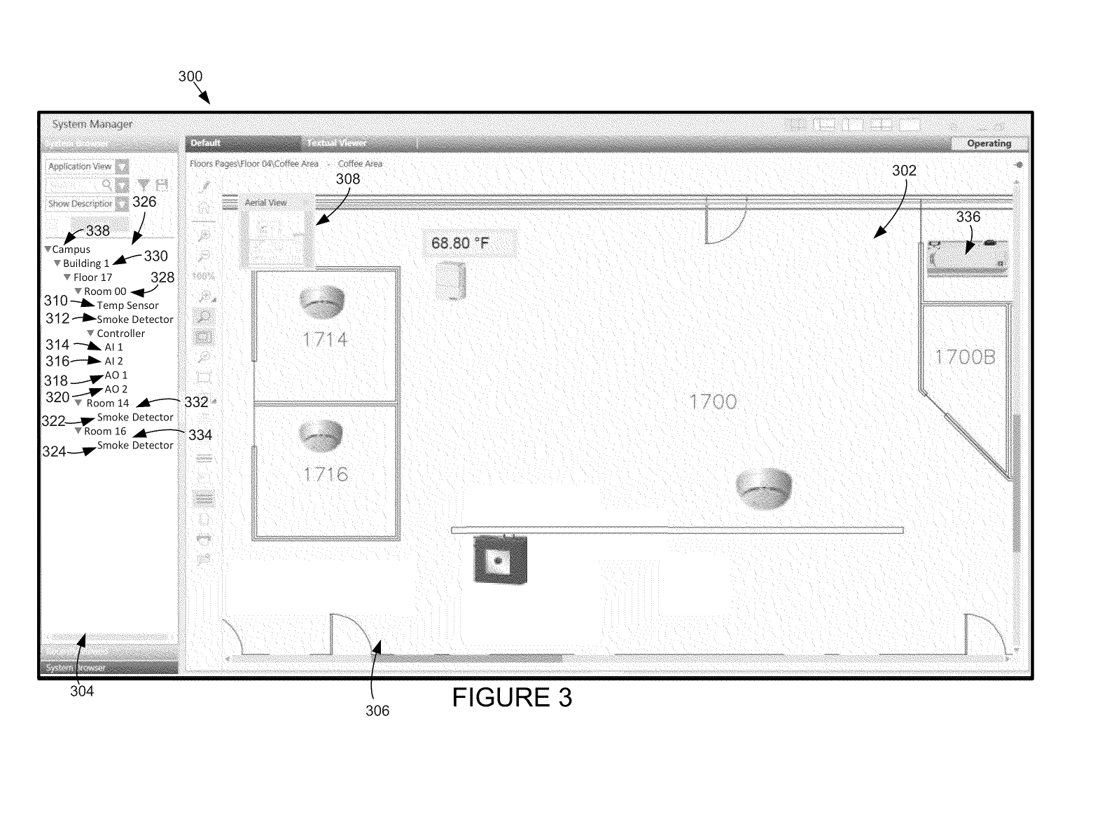

FIG. 3 illustrates a graphical user interface 300 including a logical view of system objects in a system manager application in accordance with disclosed embodiments. The graphical user interface 300 is an example of one interface generated by the data processing system 200 and the system manager application 122. In this illustrative embodiment, the graphical user interface 300 comprises a multi-area or multi-pane display window displayed on a display device (e.g., display 211 in FIG. 2). The graphical user interface 300 includes a display of a building graphic 302 and a plurality of windows 304-308. In this example, the building graphic 302 is a graphical representation of a floor of a building and is displayed in window 306.

In this illustrative embodiment, window 304 includes a logical view of object identifiers 310-324 for objects (e.g., objects 116a-n, 118a-n, and 120a-n) that are located in one or more buildings managed by the management system 100. The logical view of the objects includes a hierarchical structure 326. In this example, the hierarchical structure 326 is an organization of the object identifiers 310-324 into folders based on the location of the device in the building that the object is associated with and/or the type of the object. For example, the logical view of object identifiers 310-324 organized in the hierarchical structure 326 is one example of a logical view and hierarchical structure generated by the data processing system 200 executing the program code of the object manager application 228 in FIG. 2.

As one illustrative example, the data processing system 200 may identify from the discovery process that the devices for object identifiers 310-324 are located on floor 17 of building 1 based on name segments in the names of the objects discovered. The data processing system 200 includes the objects 310-324 in the subfolder 328 for floor 17 in the folder 330 for building 1. The data processing system 200 further identifies from the name segments that the devices for object identifiers 310 and 312 are located in room 00 while the devices for object identifiers 322 and 324 are located in rooms 14 and 16, respectively. The data processing system 200 then includes the objects 332 and 324 in separate subfolders 332 and 334 for rooms 14 and 16, respectively.

As another example, a controller in a building managed in management system 100 has four object identifiers (i.e., analog input 1 314, analog input 2 316, analog output 1 318, and analog output 2 320) associated with the controller in the hierarchical structure 326. A controller symbol 336 is displayed in the building graphics 302 as a representation of the controller located on floor 17 and room 00 of building 1. The data processing system 200 is able to identify the location of the controller from the name of the objects associated with the controller. For example, when performing the discovery process, the data processing system 200 may identify that the name of the object identifier 318 is “building1.floor17.room00.controller.AI1”. In this example, the data processing system 200 identifies that the controller is located in building one, floor 17, and room 00. The data processing system 200 also identifies the type of the object as a data point for a first analog input of the controller based on the segments “controller” and “AI1” in the identified name of the object. The data processing system 200 may identify the other objects of the controller (i.e., represented by object identifiers 314-320) and place the object identifiers 314-320 in a subfolder for the controller in the logical view of hierarchical structure 326 in window 304.

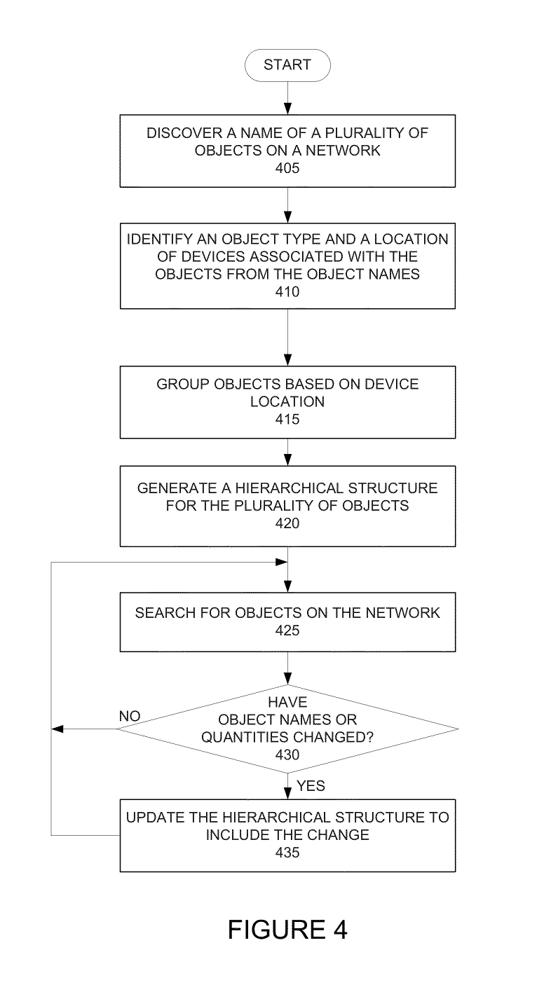

FIG. 4 depicts a flowchart of a process for generating a hierarchical structure for a plurality of objects in accordance with disclosed embodiments. This process may be performed, for example, in one or more data processing systems, such as, for example, the data processing system 200, configured to perform acts described below, referred to in the singular as “the system.” The process may be implemented by executable instructions stored in a non-transitory computer-readable medium that cause one or more data processing systems to perform such a process. For example, the object manager application 228 may comprise the executable instructions to cause one or more data processing systems to perform such a process.

The process begins with the system discovering a name of a plurality of objects on a network (step 405). In step 405, the system may perform a discovery process to discover objects on one or more specified networks. In these examples, the network may be the MLN 104, the BLN 114, or one or more FLNs located in the management system 100. For example, the system may limit results of the discovery process to devices on a specified network. In these examples, the objects are associated with devices that are present inside of or in proximity to one or more buildings managed in management system 100. The system may identify the objects on one or more networks that connect devices in the management system 100. In one embodiment, the object manager application 126 or 228 of the data processing system 102 or 200 may discover the name of an object in the system 100 by querying via the BLN network 114 each field panel or field controller on the sub-systems 106, 110, and 112 for the names of each object corresponding to a field device 116, 118, and 120 monitored or controlled by the respective field panel or field controller.

The system identifies an object type and a location of devices associated with the objects from the object names (step 410). In step 410, the system may parse characters in the object names for each object name character by character to identify name segments in the object names separated by delimiters in the name. For example, upon discovering an object name of “building1.floor17.room00.RoomTemperatureSensor”, the system may identify the type of the object as a Room Temperature Sensor that is located in building 1 on floor 17 and in room 00.

The system groups objects based on device location (step 415). In step 415, the system may identify a building, floor number and/or room number of one or more of the objects from name segments identified from names of the objects. For example, the system may group a set of objects in a room on a floor in a building within a same folder in the hierarchical structure. Continuing with the example above, the system may group all objects for devices in building 1 in a building folder, group all objects for devices on floor 17 in a floor subfolder in the building folder, and group all objects for devices in room 00 in a room subfolder in the floor subfolder.

The system generates a hierarchical structure for the plurality of objects (step 420). In step 420, the system may generate the hierarchical structure based on the type of the object and the location of the devices associated with the objects. The hierarchical structure may include different folders for objects of devices located in different buildings, floors, and rooms. The system may present the hierarchical structure as a logical view of the objects based on device location. For example, the system may generate the hierarchical structure as the hierarchical structure 326 of objects 310-324 as a logical view of objects displayed in window 304 of graphical user interface 300 in FIG. 3.

The system searches for objects on the network (step 425). For example, in step 425, the system may periodically or continuously search for objects on the network to monitor for changes on the objects on the network. In another example, the system may receive a manual input to perform a query for objects on the network and perform the search in response to receiving that input. The system determines whether object names or quantities have changed (step 430). In step 430, the system may determine whether a name of an object in the plurality of objects has changed or whether objects have been added to or removed from the network monitored. If the system determines that object names or quantities have not changed, the system returns to step 425 to continue to search for and monitor changes to the object names or quantities.

If the system determines that object names or quantities have changed, the system updates the hierarchical structure to include the change (step 435). For example, in step 435, the system may add or remove one or more objects from the hierarchical structure based on objects added to or removed from the network. The system may also move an object within the hierarchical structure based on a detected name change for the object. The system then returns to step 425 to continue to search for and monitor changes to the object names or quantities to keep the hierarchical structure updated.

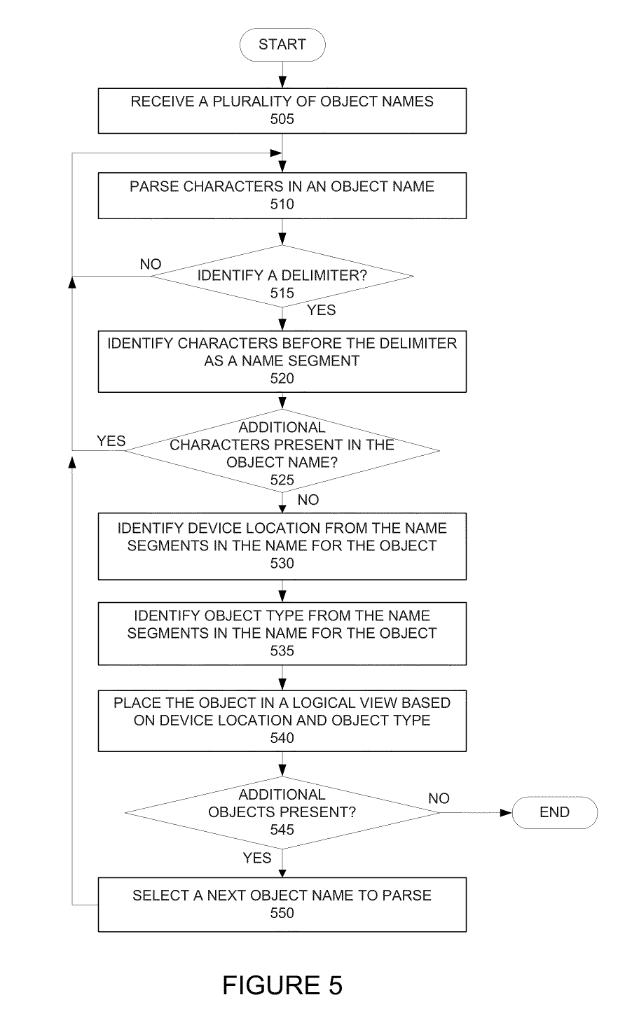

FIG. 5 depicts a flowchart of a process for identifying a type of an object and a location of a device from object names in accordance with disclosed embodiments. This process may be performed, for example, in one or more data processing systems, such as, for example, the data processing system 200, configured to perform acts described below, referred to in the singular as “the system.” The process may be implemented by executable instructions stored in a non-transitory computer-readable medium that cause one or more data processing systems to perform such a process. For example, the object manager application 228 may comprise the executable instructions to cause one or more data processing systems to perform such a process. The process described in FIG. 5 is an example of one embodiment of steps 410-420 in FIG. 4. For example, the process described in FIG. 5 provides examples on how the system may identify a type of an object and a location of a device from object names in accordance with disclosed embodiments.

The process begins with the system receiving a plurality of object names (step 505). In step 505, the system may receive the object names as a result of a discovery process, for example, as described in the discussion of the object discovery process above with regard to FIG. 2.

The system parses characters in an object name (step 510). In step 510, the system may identify each character in the object name one by one in the order of the characters in the object name. The system determines whether a delimiter has been identified in the characters (step 515). In step 515, the system may identify the delimiter as a default delimiter that is preset in the naming convention used. For example, without limitation, the delimiter may be preset as one or more of a period, comma, slash, or dash in the string of characters identified as the object name. If the system determines that a delimiter has not been identified in the characters, the system returns to step 510 and continues to parse through the characters in the object name to identify a delimiter or end of the object name.

If the system determines that a delimiter has been identified in the characters, the system identifies characters before the delimiter as a name segment (step 520). For example, the segment name may be the initial characters before a delimiter, between a pair of delimiters, or the final characters in the object name after a delimiter.

The system determines whether additional characters are present in the object name (step 525). For example, in step 525, the system may determine whether the most recently identified name segment is the last name segment in the object name. If the system determines that additional characters are present in the object name, the system returns to step 510 and continues to parse through the characters in the object name to identify additional name segments in the object name.

If the system determines that additional characters are not present in the object name, the system identifies the device location from the name segments in the name for the object (step 530). In step 530, the system may identify the location of the devices as a building, floor, or room specified in one or more of the name segments identified.

The system identifies the object type from the name segments in the name for the object (step 535). In step 535, the system may identify the type of the object in one or more of the name segments identified. For example, the system may identify that the object is an object for a specific device or type of data point associated with the device. In some examples, the system may identify that the object is for a device based on the name of the device being in a name segment in the name of the objects (e.g., a room sensor or input/output for a controller). In other examples, the system may identify that the object is an input or output data point from a device from characters in a name segment in the name of the object that are an abbreviation for an input or output (e.g., “AI” for analog input, “BO” for binary output, etc).

The system places the object in a logical view based on device location and object type (step 540). In step 540, the system place the object underneath a root node (e.g., a campus or building) in the logical view. For example, the system may receive a user input as to the building or campus that where the discovery process is performed. The system may then place all the discovered objects underneath the specified root node. For example, the system may generate a hierarchical structure as the hierarchical structure 326 of objects 310-324 as the logical view of objects generated for the root node for the folder 330 for “Building 1” and/or folder 338 for “Campus” displayed in window 304 of graphical user interface 300 in FIG. 3.

The system determines whether additional objects are present (step 545). In step 545, the system determines whether each of the discovered objects has been processed to have the location and type of the device identified from the object's name. If the system determines that additional objects are present, the system selects a next object name to parse (step 550). The system then returns to step 510 and parses the characters in the next object name to the object type and device location for the next object.

Returning to step 545, if the system determines that additional objects are not present, the system has identified the object type and device location for each of the objects identified, and the process terminates thereafter.

Disclosed embodiments provide automated discovery of objects in building automation and management systems. Disclosed embodiments provide options for configuring the discovery of objects. Disclosed embodiments provide techniques for automated creation and generation of hierarchies. The hierarchies generated in accordance with embodiments of the present disclosure provide a logical view of system objects that may match the layout of the building or buildings. Embodiments of the present disclosure allow for building managers to view and monitor objects in a manner that is organized based on the layout of devices in the building or buildings to be managed.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 200 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method in a data processing system for generating a hierarchical structure for a plurality of objects, the method comprising:
identifying a name of a first object in the plurality of objects, the plurality of objects associated with one more devices communicably connected to a building automation and controls network;
parsing characters in the name of the first object to identify a plurality of name segments separated by one or more delimiters in the name in response to identifying the one or more delimiters;
identifying a type of the first object and a location of a first device associated with the first object based on the plurality of name segments; and
generating a hierarchical structure for the plurality of objects based on the type and the location, the hierarchical structure comprising a name for each of the plurality of objects.

2. The method of claim 1, wherein generating the hierarchical structure for the plurality of objects comprises:
generating a logical view of the plurality of objects based on location of the one or more devices.

3. The method of claim 2, wherein generating the logical view of the plurality of objects based on location comprises:
identifying a general location and a specific location in the general location of one or more of the plurality of objects from name segments identified from names of the plurality of objects; and
grouping a set objects in the specific location in the general location within a same folder in the hierarchical structure.

4. The method of claim 1 further comprising:
determining whether one of a name of an object in the plurality of objects and a number of objects plurality of objects changed; and
updating the hierarchical structure for the plurality of objects to include a change in response to determining that one of a name of an object in the plurality of objects and a number of objects plurality of objects changed.

5. The method of claim 1 further comprising:
searching for the name for each of the plurality of objects on the building automation and controls network using a discovery process.

6. The method of claim 5, wherein searching for the name for each of the plurality of objects on the building automation and controls network using the discovery process comprises:
identifying a network requested to have object discovery performed; and
filtering objects discovered in the plurality of objects to objects on the requested network.

7. The method of claim 5, wherein searching for the name for each of the plurality of objects on the building automation and controls network using the discovery process comprises:
identifying a range of object identifiers requested to have object discovery performed; and
filtering objects discovered in the plurality of objects to objects within the range of requested object identifiers.

8. A data processing system configured to generate a hierarchical structure for a plurality of objects, the data processing system comprising:
a storage device comprising an object manager application;
an accessible memory comprising instructions of the object manager application; and
a processor configured to execute the instructions of the object manager application to:
identify a name of a first object in the plurality of objects, the plurality of objects associated with one more devices communicably connected to a building automation and controls network;
parse characters in the name of the first object to identify a plurality of name segments separated by one or more delimiters in the name in response to identifying the one or more delimiters;
identify a type of the first object and a location of a first device associated with the first object based on the plurality of name segments; and
generate a hierarchical structure for the plurality of objects based on the type and the location, the hierarchical structure comprising a name for each of the plurality of objects.

9. The data processing system of claim 8, wherein to generate the hierarchical structure for the plurality of objects the processor is further configured to execute the instructions of the object manager application to:
generate a logical view of the plurality of objects based on location of the one or more devices.

10. The data processing system of claim 9, wherein to generate the logical view of the plurality of objects based on location the processor is further configured to execute the instructions of the object manager application to:
identify a general location and a specific location in the general location of one or more of the plurality of objects from name segments identified from names of the plurality of objects; and
group a set objects in the specific location in the general location within a same folder in the hierarchical structure.

11. The data processing system of claim 8, wherein the processor is further configured to execute the instructions of the object manager application to:
determine whether one of a name of an object in the plurality of objects and a number of objects plurality of objects changed; and
update the hierarchical structure for the plurality of objects to include a change in response to determining that one of a name of an object in the plurality of objects and a number of objects plurality of objects changed.

12. The data processing system of claim 8, wherein the processor is further configured to execute the instructions of the object manager application to:
search for the name for each of the plurality of objects on the building automation and controls network using a discovery process.

13. The data processing system of claim 12, wherein to search for the name for each of the plurality of objects on the building automation and controls network using the discovery process the processor is further configured to execute the instructions of the object manager application to:
identify a network requested to have object discovery performed; and
filter objects discovered in the plurality of objects to objects on the requested network.

14. The data processing system of claim 12, wherein to search for the name for each of the plurality of objects on the building automation and controls network using the discovery process the processor is further configured to execute the instructions of the object manager application to:
identify a range of object identifiers requested to have object discovery performed; and
filter objects discovered in the plurality of objects to objects within the range of requested object identifiers.

15. A non-transitory computer-readable medium encoded with executable instructions that, when executed, cause one or more data processing systems to:
identify a name of a first object in the plurality of objects, the plurality of objects associated with one more devices communicably connected to a building automation and controls network;
parse characters in the name of the first object to identify a plurality of name segments separated by one or more delimiters in the name in response to identifying the one or more delimiters;
identify a type of the first object and a location of a first device associated with the first object based on the plurality of name segments; and
generate a hierarchical structure for the plurality of objects based on the type and the location, the hierarchical structure comprising a name for each of the plurality of objects.

16. The computer-readable medium of claim 15, wherein the instructions that cause the one or more data processing systems to generate the hierarchical structure for the plurality of objects comprise instructions that cause the one or more data processing systems to:
generate a logical view of the plurality of objects based on location of the one or more devices.

17. The computer-readable medium of claim 16, wherein the instructions that cause the one or more data processing systems to generate the logical view of the plurality of objects based on location comprise instructions that cause the one or more data processing systems to:
identify a general location and a specific location in the general location of one or more of the plurality of objects from name segments identified from names of the plurality of objects; and
group a set objects in the specific location in the general location within a same folder in the hierarchical structure.

18. The computer-readable medium of claim 15, wherein the computer-readable medium is further encoded with executable instructions that, when executed, cause one or more data processing systems to:
determine whether one of a name of an object in the plurality of objects and a number of objects plurality of objects changed; and
update the hierarchical structure for the plurality of objects to include a change in response to determining that one of a name of an object in the plurality of objects and a number of objects plurality of objects changed.

19. The computer-readable medium of claim 15, wherein the computer-readable medium is further encoded with executable instructions that, when executed, cause one or more data processing systems to:
search for the name for each of the plurality of objects on the building automation and controls network using a discovery process.

20. The computer-readable medium of claim 19, wherein the instructions that cause the one or more data processing systems to search for the name for each of the plurality of objects on the building automation and controls network using the discovery process comprise instructions that cause the one or more data processing systems to:
identify a network requested to have object discovery performed; and
filter objects discovered in the plurality of objects to objects on the requested network.
